(19) United States
(12) Patent Application Publication
(10) Pub. No.: US 2008/0285155 A1
(43) Pub. Date: Nov. 20, 2008

(54) IMAGE-FORMING LENS SET

(75) Inventors: Hung-Chih Li, Taichung City (TW); Shih-Han Chen, Taipei County (TW)

Correspondence Address: BROWDY AND NEIMARK, P.L.L.C.;624 NINTH STREET, NW, SUITE 300, WASHINGTON, DC, 20001-5303, US

(73) Assignee: Genius Electronic Optical Co., Ltd., Taichung (TW)

(21) Appl. No.: 11/749,978

(22) Filed: May 17, 2007

(51) Int. Cl. G02B 13/18

(52) U.S. Cl. 359/717; 359/708

(57) ABSTRACT

An image-forming lens set includes a positive power first lens, an aperture stop, a negative power second lens and a positive power third lens, which are arranged from an object side in order. The first lens has a convex surface facing the object side, and at least one surface thereof is a non-spherical surface. The second lens is a convex-concave lens having a concave surface facing the object side, and at least one surface thereof is a non-spherical surface. The third lens has two non-spherical opposite surfaces including a convex surface facing the object side. At least one of the first, second and third lenses is coated with a layer of optical film for filtering light. By means of the lenses having non-spherical surfaces, the image-forming lens set has a simple structure. By means of the optical film, the image formed in a better quality can achieve.

### BACKGROUND OF THE INVENTION

1. Field of the Invention

The present invention relates generally to image-forming lenses and more particularly, to an image-forming lens set having a plurality of lenses.

2. Description of the Related Art

Following fast development of multimedia technology, image-forming lenses have been intensively used in a variety of mobile electronic products such as digital camera, mobile camera telephone, personal digital assistant (PDA), and etc., for picking up images.

Further, to satisfy the requirements of high-tech product users for better convenience, quality and utility, high-tech products must be small-sized while maintaining the quality and lowering the cost. Image-forming lens sets encounter the same market challenge, i.e., image-forming lens sets must have a simple structure design to lower the cost and reduce the aberrations so as to improve the quality and reduce the size, satisfying the requirement for better product utility.

### SUMMARY OF THE INVENTION

The present invention has been accomplished under the circumstances in view. It is one objective of the present invention to provide a simple structure of image-forming lens set that is easy and inexpensive to manufacture and that provides a high image quality.

To achieve this objective of the present invention, the image-forming lens set comprises a first lens with positive power, an aperture stop, a second lens with negative power and a third lens with positive power, which are arranged along an optical axis from an object side toward an image side in order. The first lens has two opposite surfaces including a convex surface facing the object side, and at least one of the two opposite surfaces is a non-spherical surface. The second lens is a convex-concave lens having two opposite surfaces including a concave surface facing the object side, and at least one of the two opposite surfaces of the second lens is a non-spherical surface. The third lens has two non-spherical opposite surfaces including a convex surface facing the object side. At least one of the first, second and third lenses is coated with a layer of optical film for filtering light. By means of the lenses having non-spherical surfaces, the image-forming lens set has a simple structure. By means of the optical film, the image formed in a better quality can achieve.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus is not limitative of the present invention, and wherein:

FIG. 1 is a schematic drawing showing the structure of an image-forming lens set according to a preferred embodiment of the present invention.

### DETAILED DESCRIPTION OF THE INVENTION

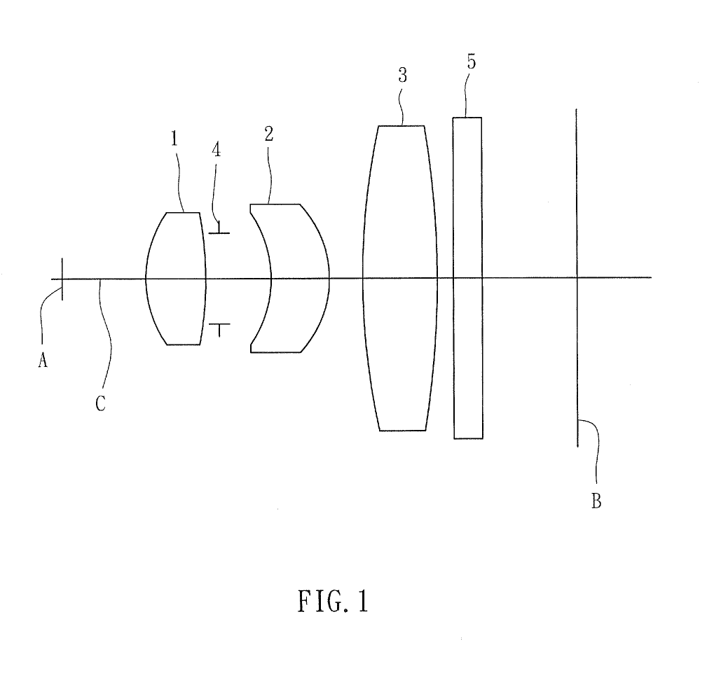

Referring to the annexed drawing of FIG. 1, an image-forming lens set in accordance with a preferred embodiment of the present invention is shown comprising a first lens 1, a second lens 2, a third lens 3, and an aperture stop 4.

The component parts of the image-forming lens set are arranged from the object side A toward the image side B (the image forming surface of the image sensor of charge coupled device (CCD) or complementary metal-oxide semiconductor (CMOS)) along an optical axis C in the order of: the first lens 1, the aperture stop 4, the second lens 2 and the third lens 3. The first lens 1, which is a biconvex lens with positive power, has at least one non-spherical surface of the two opposite surfaces thereof. The aperture stop 4 is spaced between the first lens 1 and the second lens 2. The second lens 2, which is a convex-concave lens with negative power, has at least one non-spherical surface of the two opposite surfaces thereof. The surface of the second lens 2 that faces the object side A is a concave surface. The third lens 3, which is a biconvex lens with positive power, has two non-spherical opposite surfaces. In this preferred embodiment of the present invention, the third lens 3 is embodied as a positive power biconvex lens. Alternatively, a positive power convex-concave lens having its convex surface facing the object side can also be used as the third lens instead of the positive power biconvex lens.

The aforesaid image-forming lens set satisfies the following equations.

−1.5−(F1+F2)/F≦0.3 [Equation 1]

in which:
F1 is the effective focal length of the first lens 1;
F2 is the effective focal length of the second lens 2; and
F is the effective focal length of the image-forming lens set.

0.01<|F1/F2|<1 [Equation 2]

in which:
F1 is the effective focal length of the first lens 1; and
F2 is the effective focal length of the second lens 2.

0.2<D3/D5<1.8 [Equation 3]

in which:

D3 is the distance between the point of the optical axis C at the surface of the second lens 2 that faces the object side A and the point of the optical axis C at the surface of the second lens 2 that faces the image side B; and

D5 is the distance between the point of the optical axis C at the surface of the third lens 3 that faces the object side A and the point of the optical axis C at the surface of the third lens 3 that faces the image side B.

D4/F<0.3 [Equation 4]

in which:

D4 is the distance between the point of the optical axis C at the surface of the second lens 2 that faces the image side B and the point of the optical axis C at the surface of the third lens 3 that faces the object side A; and

F is the effective focal length of the image-forming lens set.

Further, the surfaces of the first lens 1, second lens 2 and third lens 3 that face the object side A may be respectively coated with a layer of anti-reflective film to enhance optical transmission of the lenses 1-3, thereby obtaining a better image forming effect.

Further, a fourth planar lens 5 of glass may be set between the third lens 3 and the image side B to greatly improve the modulation transfer function (MTF) of the image forming lens set, thereby minimizing spherical aberration, distortion aberration, curvature of field and coma aberration. Further, the surface of the fourth lens 5 that faces the image side B is coated with a layer of optical film (filter) that interferes with or absorbs wavelength that is not sensitive to human eyes so as to remove scattered signal during image forming, thereby obtaining a better image quality.

It is to be understood that one surface of one of the three lenses 1-3 can be also coated with a layer of filter to eliminate scattered signal. In this case, the aforesaid fourth lens 5 is unnecessary.

Further, a protective glass may be set between the third lens 3 and the image side B, or the fourth lens 3 may be used for direct protection against external particles, thereby obtaining a better image quality.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image-forming lens set comprising a first lens with positive power, an aperture stop, a second lens with negative power and a third lens with positive power, which are arranged along an optical axis from an object side toward an image side in order;
wherein the first lens has two opposite surfaces including a convex surface facing the object side, and at least one of the two opposite surfaces is a non-spherical surface;
wherein the second lens is a convex-concave lens having two opposite surfaces including a concave surface facing the object side, and at least one of the two opposite surfaces of the second lens is a non-spherical surface;
wherein the third lens has two non-spherical opposite surfaces including a convex surface facing the object side;
wherein at least one of the first, second and third lenses is coated with a layer of optical film for filtering light.

2. The image-forming lens set as claimed in claim 1, which satisfies the Equation 1 as follows:
−1.5−<(F1+F2)/F≦0.3 [Equation 1]
in which:
F1 is the effective focal length of the first lens;
F2 is the effective focal length of the second lens; and
F is the effective focal length of the image-forming lens set.

3. The image-forming lens set as claimed in claim 1, which satisfies the Equation 2 as follows:
0.01<|F1/F2|<1 [Equation 2]
in which:
F1 is the effective focal length of the first lens; and
F2 is the effective focal length of the second lens.

4. The image-forming lens set as claimed in claim 1, which satisfies the Equation 3 as follows:
0.2<D3/D5<1.8 [Equation 3]
in which:
D3 is the distance between the point of the optical axis at the surface of the second lens that faces the object side and the point of the optical axis at the surface of the second lens that faces the image side; and
D5 is the distance between the point of the optical axis at the surface of the third lens that faces the object side and the point of the optical axis at the surface of the third lens that faces the image side.

5. The image-forming lens set as claimed in claim 1, which satisfies the Equation 4 as follows:
D4/F<0.3 [Equation 4]
in which:
D4 is the distance between the point of the optical axis at the surface of the second lens that faces the image side and the point of the optical axis at the surface of the third lens that faces the object side; and
F is the effective focal length of the image-forming lens set.

6. The image-forming lens set as claimed in claim 1, wherein one of the first, second and third lenses is coated with an optical film for enhancing light transmission.

7. The image-forming lens set as claimed in claim 1, further comprising a protective glass located between the third lens and the image side.

8. The image-forming lens set as claimed in claim 1, wherein the third lens is a biconvex lens.

9. The image-forming lens set as claimed in claim 1, wherein the third lens is a convex-concave lens.

10. An image-forming lens set comprising a first lens with positive power, an aperture stop, a second lens with negative power, a third lens with positive power and a fourth lens, which are arranged along an optical axis from an object side toward an image side in order;
wherein the first lens has two opposite surfaces including a convex surface facing the object side, and at least one of the two opposite surfaces is a non-spherical surface;
wherein the second lens is a convex-concave lens having two opposite surfaces including a concave surface facing the object side, and at least one of the two opposite surfaces of the second lens is a non-spherical surface;
wherein the third lens has two non-spherical opposite surfaces including a convex surface facing the object side;
wherein the fourth lens is coated with a layer of optical film for filtering light.

11. The image-forming lens set as claimed in claim 10, wherein the fourth lens is a planar lens made of glass.

12. The image-forming lens set as claimed in claim 10, wherein at least one of the first, second and third lenses is coated with an optical film for enhancing light transmission.
